(19) United States
(12) Patent Application Publication
(10) Pub. No.: US 2017/0177443 A1
(43) Pub. Date: Jun. 22, 2017

(54) POINT-IN-TIME-COPY CREATION FOR DIRECT CLOUD BACKUP

(71) Applicant: International Business Machines Corporation, Armonk, NY (US)

(72) Inventors: Ernesto E. Figueroa, Sahuarita, AZ (US); Robert S. Gensler, JR., Beavercreek, OH (US); David M Shackelford, Tucson, AZ (US); Jeffrey R. Suarez, Tucson, AZ (US)

(73) Assignee: International Business Machines Corporation, Armonk, NY (US)

(21) Appl. No.: 14/975,800

(22) Filed: Dec. 20, 2015

(51) Int. Cl. G06F 11/14; H04L 29/08

(52) U.S. Cl. CPC G06F 11/1451; G06F 11/1464; H04L 67/1097; H04L 67/1095; G06F 2201/84

(57) ABSTRACT

A method for backing up data is disclosed. In one embodiment, such a method includes sending, from a host system to a storage system, a first request to make a logical point-in-time copy of production data on the storage system. The storage system executes the first request by creating the logical point-in-time copy thereon. An identifier is assigned to the logical point-in-time copy. The method further sends, from the host system to the storage system, a second request to directly copy a specified portion of data in the logical point-in-time copy to cloud storage. The second request identifies the logical point-in-time copy using the identifier. The storage system executes the second request by directly copying the specified portion from the logical point-in-time copy to the cloud storage. A corresponding system and computer program product are also disclosed.

### BACKGROUND

Field of the Invention

This invention relates to systems and methods for backing up data, particularly to cloud-based storage systems.

Background of the Invention

Today, when backing up production data residing on a storage system, the Concurrent Copy function may be used to reduce the amount of time that production data is unavailable to applications. In particular, the Concurrent Copy function may be used to generate, on the storage system, a logical point-in-time copy of the production data by creating a side file that tracks changes to the production data after the logical point-in-time copy is created. Once the logical point-in-time copy is created, a backup process (executing on a host system) may be used to back up the point-in-time copy to backup storage. This frees up the production data for access by other applications. The backup process may read and back up data directly from the production data for data that has not changed since creation of the logical point-in-time copy. By contrast, the backup process may read and back up data from the side file for data that has changed since creation of the logical point-in-time copy.

Current implementations of Concurrent Copy limit the amount of data that can be stored in cache of the storage system. For example, if more than sixty percent of the cache is occupied by the side file, the remainder of the side file may need to be stored in virtual storage (i.e., memory) of the host system. This may create additional overhead to locate and back up data in the side file. Another drawback of Concurrent Copy and other point-in-time copy functions is that these functions typically cannot be used to back up production data to cloud storage. Rather, when backing up production data to cloud storage, the production data typically has to be serialized (locked) and copied to backup storage before the production data can be unlocked and accessed by other applications.

In view of the foregoing, what are needed are systems and methods to more efficiently back up production data, particularly to cloud-based storage systems. Further needed are systems and methods to utilize point-in-time copy functions such as Concurrent Copy when backing up production data to cloud-based storage systems.

### SUMMARY

The invention has been developed in response to the present state of the art and, in particular, in response to the problems and needs in the art that have not yet been fully solved by currently available systems and methods. Accordingly, the invention has been developed to provide systems and methods to more effectively back up data, particularly to cloud-based storage systems. The features and advantages of the invention will become more fully apparent from the following description and appended claims, or may be learned by practice of the invention as set forth hereinafter.

Consistent with the foregoing, a method for backing up data is disclosed herein. In one embodiment, such a method includes sending, from a host system to a storage system, a first request to make a logical point-in-time copy of production data on the storage system. The storage system executes the first request by creating the logical point-in-time copy thereon. An identifier is assigned to the logical point-in-time copy. The method further sends, from the host system to the storage system, a second request to directly copy a specified portion of data in the logical point-in-time copy to cloud storage. The second request identifies the logical point-in-time copy using the identifier. The storage system executes the second request by directly copying the specified portion from the logical point-in-time copy to the cloud storage.

A corresponding system and computer program product are also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a high-level block diagram showing an exemplary environment in which embodiments of the invention may operate;

FIG. 2 is a high-level block diagram showing one embodiment of a storage system in which embodiments of the invention may operate;

FIG. 3 is a high-level block diagram showing various modules that may be used to implement systems and methods in accordance with the invention;

FIG. 4 is a high-level block diagram showing a first request, transmitted from a host system to a storage system, to create a logical point-in-time copy on the storage system;

FIG. 5 is a high-level block diagram showing an acknowledgement, transmitted from the storage system to the host system, indicating that the logical point-in-time copy has been created;

FIG. 6 is a high-level block diagram showing a second request, transmitted from the host system to the storage system, to back up the logical point-in-time copy to backup storage; and

FIG. 7 is a high-level block diagram showing an acknowledgement, transmitted from the storage system to the host system, indicating that the backup of the logical point-in-time copy is complete;

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The present invention may be embodied as a system, method, and/or computer program product. The computer program product may include a computer readable storage medium (or media) having computer readable program instructions stored thereon for causing a processor to carry out aspects of the present invention.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer-readable program instructions for carrying out operations of the present invention may be assembler instructions, instruction-set-architecture (ISA) instructions, machine instructions, machine-dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages.

The computer readable program instructions may execute entirely on a user's computer, partly on a user's computer, as a stand-alone software package, partly on a user's computer and partly on a remote computer, or entirely on a remote computer or server. In the latter scenario, a remote computer may be connected to a user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, may be implemented by computer-readable program instructions.

These computer-readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

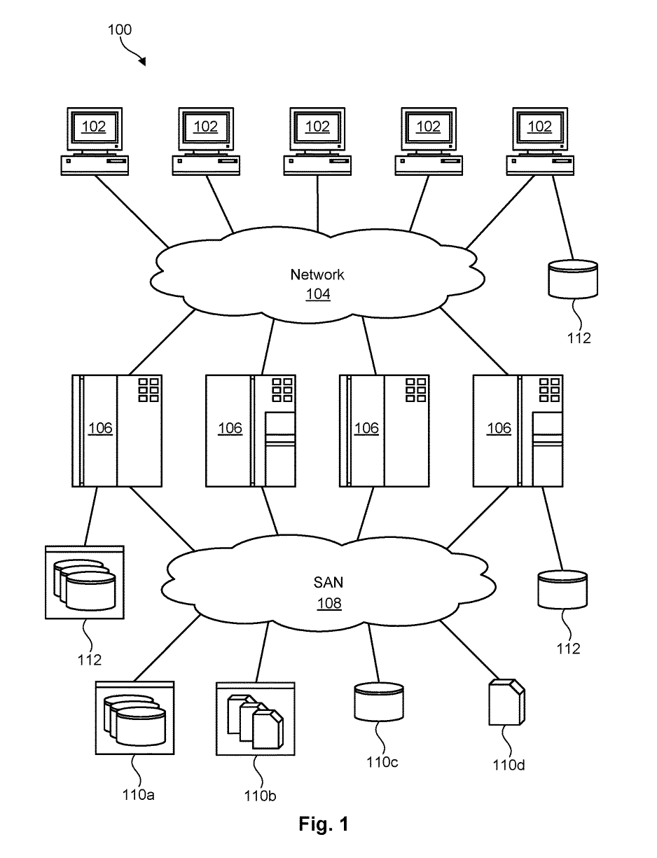

Referring to FIG. 1, one example of a network environment 100 is illustrated. The network environment 100 is presented to show one example of an environment where systems and methods in accordance with the invention may be implemented. The network environment 100 is presented only by way of example and not limitation. Indeed, the systems and methods disclosed herein may be applicable to a wide variety of network environments, in addition to the network environment 100 shown.

As shown, the network environment 100 includes one or more computers 102, 106 interconnected by a network 104. The network 104 may include, for example, a local-area-network (LAN) 104, a wide-area-network (WAN) 104, the Internet 104, an intranet 104, or the like. In certain embodiments, the computers 102, 106 may include both client computers 102 and server computers 106 (also referred to herein as “host systems” 106). In general, the client computers 102 initiate communication sessions, whereas the server computers 106 wait for requests from the client computers 102. In certain embodiments, the computers 102 and/or servers 106 may connect to one or more internal or external direct-attached storage systems 112 (e.g., arrays of hard-disk drives, solid-state drives, tape drives, etc.). These computers 102, 106 and direct-attached storage systems 112 may communicate using protocols such as ATA, SATA, SCSI, SAS, Fibre Channel, or the like.

The network environment 100 may, in certain embodiments, include a storage network 108 behind the servers 106, such as a storage-area-network (SAN) 108 or a LAN 108 (e.g., when using network-attached storage). This network 108 may connect the servers 106 to one or more storage systems 110, such as arrays 110a of hard-disk drives or solid-state drives, tape libraries 110b, individual hard-disk drives 110c or solid-state drives 110c, tape drives 110d, CD-ROM libraries, or the like. To access a storage system 110, a host system 106 may communicate over physical connections from one or more ports on the host 106 to one or more ports on the storage system 110. A connection may be through a switch, fabric, direct connection, or the like. In certain embodiments, the servers 106 and storage systems 110 may communicate using a networking standard such as Fibre Channel (FC).

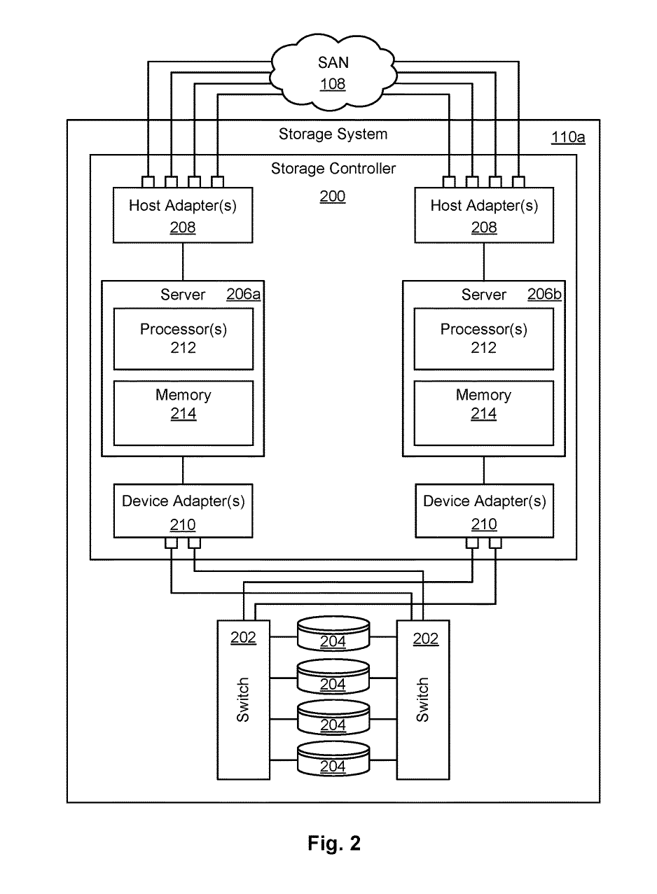

Referring to FIG. 2, one embodiment of a storage system 110a containing an array of hard-disk drives 204 and/or solid-state drives 204 is illustrated. As shown, the storage system 110a includes a storage controller 200, one or more switches 202, and one or more storage devices 204, such as hard disk drives 204 or solid-state drives 204 (such as flash-memory-based drives 204). The storage controller 200 may enable one or more hosts 106 (e.g., open system and/or mainframe servers 106 running operating systems such as MVS, z/OS, or the like) to access data in the one or more storage devices 204.

In selected embodiments, the storage controller 200 includes one or more servers 206. The storage controller 200 may also include host adapters 208 and device adapters 210 to connect the storage controller 200 to host devices 106 and storage devices 204, respectively. Multiple servers 206a, 206b may provide redundancy to ensure that data is always available to connected hosts 106. Thus, when one server 206a fails, the other server 206b may pick up the I/O load of the failed server 206a to ensure that I/O is able to continue between the hosts 106 and the storage devices 204. This process may be referred to as a “failover.”

In selected embodiments, each server 206 may include one or more processors 212 and memory 214. The memory 214 may include volatile memory (e.g., RAM) as well as non-volatile memory (e.g., ROM, EPROM, EEPROM, hard disks, flash memory, etc.). The volatile and non-volatile memory may, in certain embodiments, store software modules that run on the processor(s) 212 and are used to access data in the storage devices 204. The servers 206 may host at least one instance of these software modules. These software modules may manage all read and write requests to logical volumes in the storage devices 204.

One example of a storage system 110a having an architecture similar to that illustrated in FIG. 2 is the IBM DS8000™ enterprise storage system. The DS8000™ is a high-performance, high-capacity storage controller providing disk storage that is designed to support continuous operations. Nevertheless, the systems and methods disclosed herein are not limited to operation with the IBM DS8000™ enterprise storage system 110a, but may operate with any comparable or analogous storage system 110, regardless of the manufacturer, product name, or components or component names associated with the system 110. Furthermore, any storage system that could benefit from one or more embodiments of the invention is deemed to fall within the scope of the invention. Thus, the IBM DS8000™ is presented only by way of example and is not intended to be limiting.

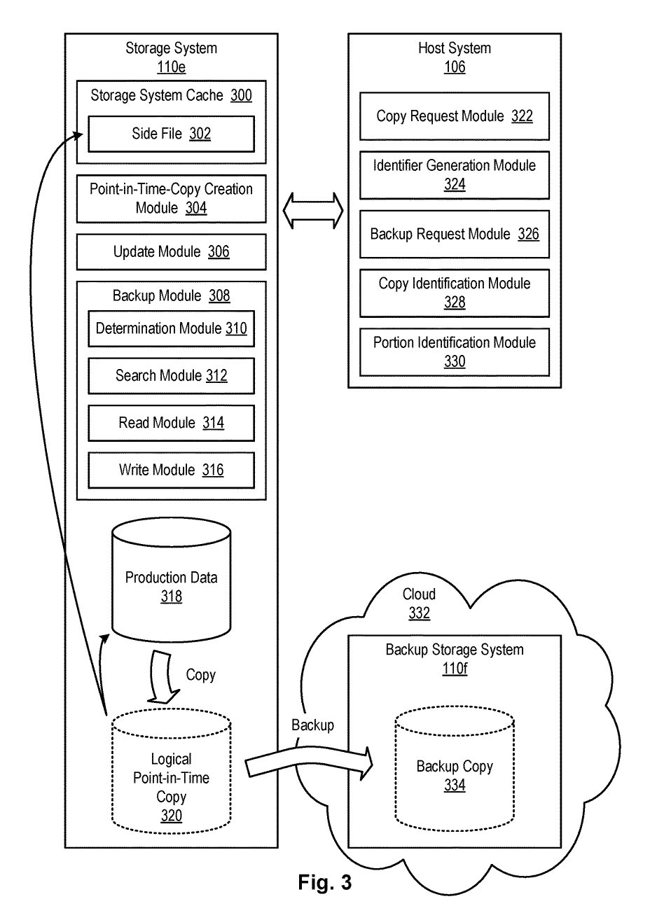

Referring to FIG. 3, as previously mentioned, in certain environments, point-in-time copy technologies such as Concurrent Copy may be used to back up production data 318 stored on a storage system 110. Unfortunately, point-in-time copy technologies such as Concurrent Copy typically cannot be used to back up data to cloud storage. Furthermore, most backup processes require involvement by host systems 106, namely to read data from point-in-time copies on a storage system 110e, and write the data to a backup storage system 110f. This can impose a significant amount of additional stress and overhead on host systems 106.

In order to address the deficiencies identified above, a backup module 308 may be implemented within a storage system 110e (which may include, for example, a disk array 110a or other suitable storage system 110) to backup data stored thereon. This backup module 308 may work in conjunction with a point-in-time-copy module 304 to back up production data 318 to a backup storage system 110f (which may include, for example, a disk array 110a or other suitable storage system 110) while limiting the amount of time that the production data 318 is unavailable for access by other applications. The production data 318 include all production data 318 on the storage system 110e or, in other embodiments, certain volumes or portions of production data 318 on the storage system 110e.

To implement such a system and method, one or more modules may be present the storage system 110e as well as a host system 106 accessing the storage system 110e. For example, the host system 106 may include one or more of a copy request module 322, identifier generation module 324, backup request module 326, copy identification module 328, and portion identification module 330. The storage system 110e may include an update module 306 in addition to the point-in-time-copy module 304 and backup module 308 previously discussed. These modules may be implemented in software, hardware, firmware, or a combination thereof.

In operation, the copy request module 322 on the host system 106 may generate a request to create a point-in-time copy 320 of production data 318 on the storage system 110e. Similarly, the identifier generation module 324 may generate an identifier (e.g., session ID, number, object name, etc.) associated with the point-in-time copy 320. The request along with the identifier may be transmitted to the storage system 110e. In response to the request, the point-in-time-copy module 304 may generate the point-in-time copy 320 of the production data 318 with the provided identifier. The identifier may be used to identify the point-in-time copy 320 as well as differentiate the point-in-time copy 320 from other point-in-time copies 320 that may be present on the storage system 110e.

The point-in-time copy 320 may be a logical point-in-time copy 320 meaning that no (or very little) actual data may be copied at the time the point-in-time copy 320 is created. Rather, the point-in-time copy 320 may consist of the production data 318 (for data that has not changed) as well as a side file 302 that keeps track of changes to the production data 318 after the point-in-time copy 320 is created. All or part of the side file 302 may, in certain embodiments, be stored in cache 300 of the storage system 110e.

During creation of the point-in-time copy 320, the production data 318 may be serialized (i.e., locked). Since no data needs to be copied, this lock may be very brief (e.g., on the order of seconds), thereby freeing up the production data 318 for access by other applications. Once the point-in-time copy 320 is created, the update module 306 may keep track of changes to the production data 318 by writing to the side file 302. For example, if, after creation of the point-in-time copy 320, data is written to tracks of the production data 318, the update module 306 may store the previous version of the tracks in the side file 302, thereby retaining the state of the production data 318 at the time of the point-in-time copy 320.

The backup request module 326 on the host system 106 may generate a request to back up a point-in-time copy 320 on the storage system 110e to the backup storage system 110f. To make such a request, the copy identification module 328 may identify the point-in-time copy 320 to be backed up by specifying the identifier previously discussed. The portion identification module 330 may identify specific portions of the point-in-time copy 320 to back up. For example, the portion identification module 330 may identify specific tracks or other storage or data elements to be backed up in the point-in-time copy 320. This allows specific portions to be backed up as opposed to the entire point-in-time copy 320, although the entire point-in-time copy 320 may also be backed up, if desired. The backup request may then be transmitted to the storage system 110e along with the identifier associated with the point-in-time copy 320 and specific portions within the point-in-time copy 320. In certain embodiments, the backup request module 326 may also provide, to the storage system 110e, a cloud name, container name, and/or object name that data should be stored under in a cloud object store.

The backup module 308 may then back up the point-in-time copy 320 in accordance with the received request. That is, the backup module 308 may copy the specific portions of the point-in-time copy 320 to the backup storage system 110f to create a backup copy 334. As shown in FIG. 3, this backup storage system 110f may, in certain embodiments, be located in the cloud 332. That is, the backup storage system 110f may provided as a service over a network such as the Internet to store the production data 318, or portions thereof, as objects or blocks. Because the backup module 308 is located within the storage system 110e, once the backup request is received, the storage system 110e may be configured to perform the backup with little or no host involvement. That is, the backup module 308 may directly copy the point-in-time copy 320, or portions thereof, to the backup storage system 110f with little or no involvement of the host system 106. This reduces stress and/or overhead on the host system 106.

To back up the point-in-time copy 320, the backup module 308 may include one or more sub-modules 310, 312, 314, 316. These sub-modules may include one or more of a determination module 310, search module 312, read module 314, and write module 316. When a backup request is received from the host system 106, the determination module 310 may determine which point-in-time copy 320 to back up (using the identifier previously discussed) as well as the specific portions in the point-in-time copy 320 to back up. The search module 312 may then search for the point-in-time copy 320 and the specific portions to back up. Once the point-in-time copy 320 is located, the search module 312 may initially search the production data 318 for tracks (or other storage elements) identified in the request. Tracks that have not been updated since creation of the point-in-time copy 320 may be found in the production data 318. Tracks that have been updated since creation of the point-in-time copy 320 may be found in the side file 302.

In certain embodiments, tracks (or other storage elements) in the side file 302 may not be stored in the same order in which they are found in the production data 318 since the tracks may be written to the side file 302 in the order in which they are updated. Thus, the search module 312 may need to search through the side file 302 to find the tracks identified for back up. When tracks identified for back up are located in the production data 318 and/or side file 302, the read module 314 may read the tracks and the write module 316 may write the tracks to the backup copy 334 on the backup storage system 110f. Although tracks stored in the side file 302 may not be in the same order as the production data 318, these tracks may nevertheless need to be written to the cloud 332 in order. Thus, in certain embodiments, tracks are searched for in order and/or sorted and written to the backup storage system 110f in order.

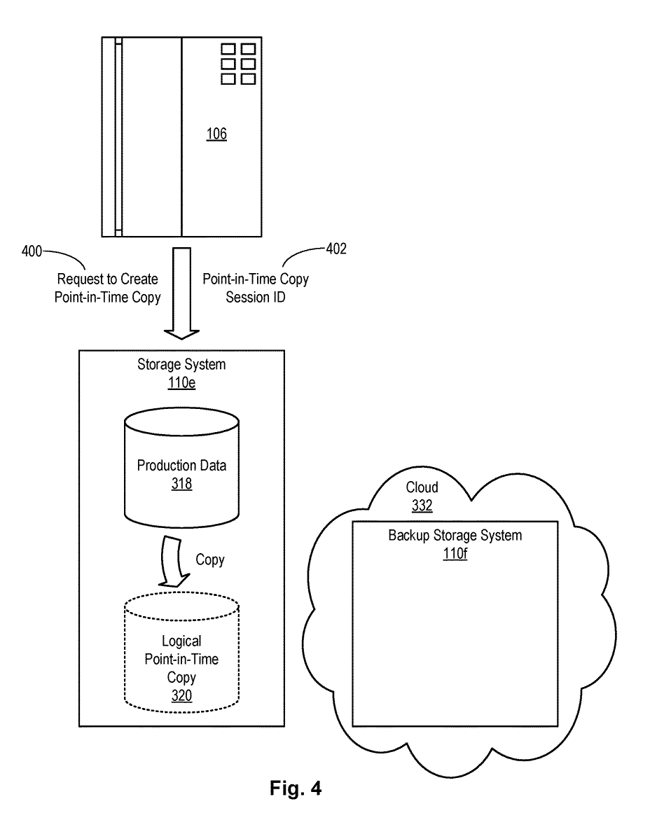

Referring generally to FIGS. 4 through 7, interaction between the host system 106, storage system 110e, and backup storage system 110f when backing up production data 318, is illustrated. As shown in FIG. 4, a host system 106 may initially transmit a request 400 to create a point-in-time copy 320 to the storage system 110e. As shown, the host system 106 generates a point-in-time copy session ID 402 (an example of an identifier) and transmits this session ID 402 to the storage system 110e either with the request 400 or as a separate message. Alternatively, the storage system 110e may generate the session ID 402 to assign to the point-in-time copy 320 and return this ID to the host system 106. In response to the request 400, the storage system 110e creates a logical point-in-time copy 320 of production data 318 residing on the storage system 110e and assigns the session ID 402 to the point-in-time copy 320.

As previously mentioned the point-in-time copy 320 may be “logical” in that no or very little data may be actually copied when creating the point-in-time copy 320. Rather, the point-in-time copy 320 may consist of the production data 318 for data that has not changed, and a side file 302 for production data 318 that has changed since creation of the point-in-time copy 320.

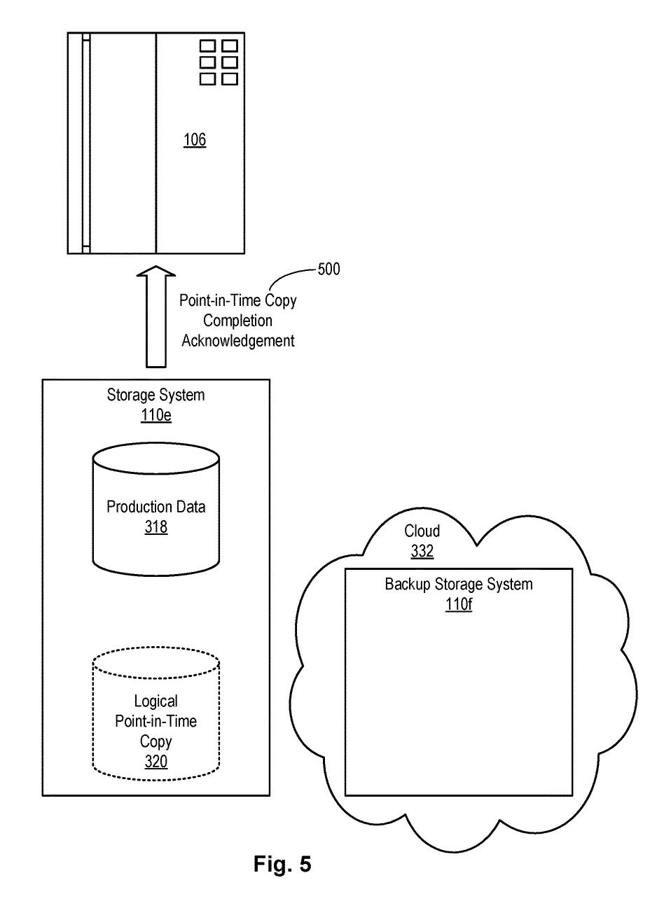

Once the point-in-time copy 320 has been created, the storage system 110e may return an acknowledgement 500 to the host system 106 that indicates that the point-in-time copy 320 has been successfully created, as shown in FIG. 5. This may enable the host system 106 to unlock the production data 318, thereby allowing immediate access to other applications/systems.

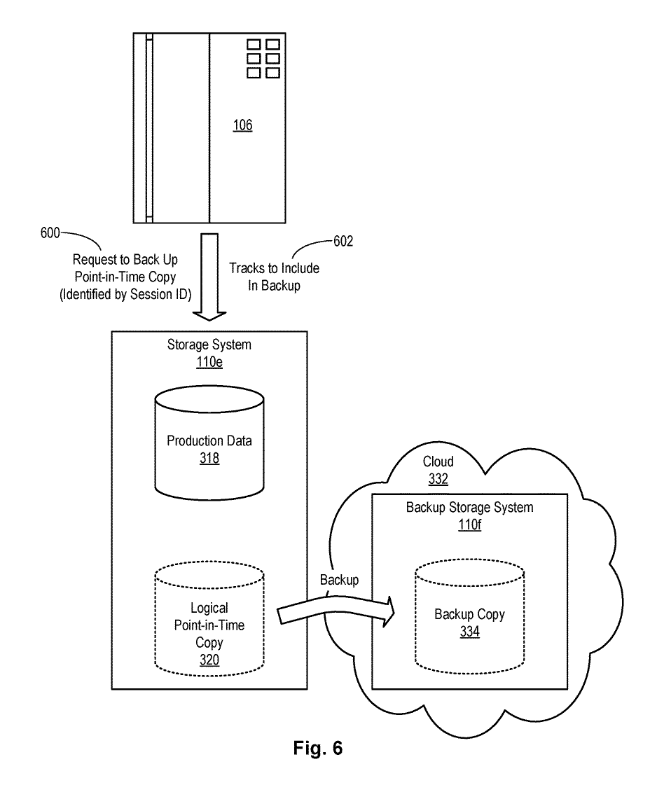

Once the point-in-time copy 320 is created on the storage system 110e, the host system 106 may transmit a request 600 to back up the point-in-time copy 320 to the storage system 110e, as shown in FIG. 6. The session ID associated with the point-in-time copy 320 may be provided with the request 600 or sent as a separate message. In certain embodiments, the request 600 or a separate message 602 identifies tracks (or other storage elements) in the point-in-time copy 320 to back up. In certain embodiments, the host system 106 may also provide, to the storage system 110e, a cloud name, container name, and/or object name that data should be stored under in a cloud object store.

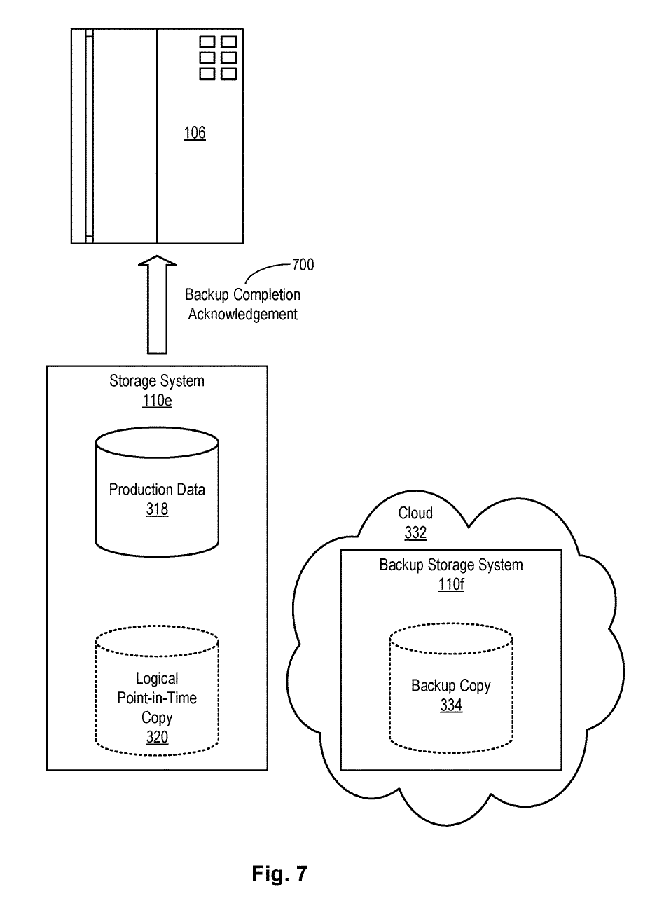

In response to the request 600, the backup module 308 in the storage system 110e may back up the identified tracks in the point-in-time copy 320. This may be accomplished by searching for the tracks either in the production data 318 or the side file 302, reading the tracks, and then writing the tracks to a backup storage system 110f to create a backup copy 334. As shown in FIG. 7, once the backup is complete, the storage system 110e may return an acknowledgment 700 to the host system 106 indicating that the requested backup is complete.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A method for backing up data, the method comprising:
sending, from a host system to a storage system, a first request to make a logical point-in-time copy of production data on the storage system;
executing, by the storage system, the first request by creating the logical point-in-time copy on the storage system;
assigning an identifier to the logical point-in-time copy;
sending, from the host system to the storage system, a second request to directly copy a specified portion of data in the logical point-in-time copy to cloud storage, the second request identifying the logical point-in-time copy using the identifier; and
executing, by the storage system, the second request by directly copying the specified portion from the logical point-in-time copy to the cloud storage.

2. The method of claim 1, wherein the specified portion is all of the data associated with the logical point-in-time copy.

3. The method of claim 1, wherein the specified portion is part of the data associated with the logical point-in-time copy.

4. The method of claim 1, wherein creating the logical point-in-time copy comprises creating a side file that keeps track of changes to the production data.

5. The method of claim 1, wherein directly copying the specified portion comprises copying the production data for data that hasn't changed since creation of the logical point-in-time copy, and copying the side file for data that has changed since creation of the logical point-in-time copy.

6. The method of claim 1, wherein the identifier is a session identifier identifying the logical point-in-time copy.

7. The method of claim 1, wherein the specified portion identifies tracks in the logical point-in-time copy.

8. A computer program product for backing up data, the computer program product comprising a computer-readable medium having computer-usable program code embodied therein, the computer-usable program code comprising:
computer-usable program code to send, from a host system to a storage system, a first request to make a logical point-in-time copy of production data on the storage system;
computer-usable program code to enable the storage system execute the first request by creating the logical point-in-time copy on the storage system;
computer-usable program code to assign an identifier to the logical point-in-time copy;
computer-usable program code to send, from the host system to the storage system, a second request to directly copy a specified portion of data in the logical point-in-time copy to cloud storage, the second request identifying the logical point-in-time copy using the identifier; and
computer-usable program code to enable the storage system to execute the second request by directly copying the specified portion from the logical point-in-time copy to the cloud storage.

9. The computer program product of claim 8, wherein the specified portion is all of the data associated with the logical point-in-time copy.

10. The computer program product of claim 8, wherein the specified portion is part of the data associated with the logical point-in-time copy.

11. The computer program product of claim 8, wherein creating the logical point-in-time copy comprises creating a side file that keeps track of changes to the production data.

12. The computer program product of claim 8, wherein directly copying the specified portion comprises copying the production data for data that hasn't changed since creation of the logical point-in-time copy, and copying the side file for data that has changed since creation of the logical point-in-time copy.

13. The computer program product of claim 8, wherein the identifier is a session identifier identifying the logical point-in-time copy.

14. The computer program product of claim 8, wherein the specified portion identifies tracks in the logical point-in-time copy.

15. A system for backing up data, the system comprising:
at least one processor;
at least one memory device operably coupled to the at least one processor and storing instructions for execution on the at least one processor, the instructions causing the at least one processor to:
send, from a host system to a storage system, a first request to make a logical point-in-time copy of production data on the storage system;
enable the storage system to execute the first request by creating the logical point-in-time copy on the storage system;
assign an identifier to the logical point-in-time copy;
send, from the host system to the storage system, a second request to directly copy a specified portion of data in the logical point-in-time copy to cloud storage, the second request identifying the logical point-in-time copy using the identifier; and
enable the storage system to execute the second request by directly copying the specified portion from the logical point-in-time copy to the cloud storage.

16. The system of claim 15, wherein the specified portion is all of the data associated with the logical point-in-time copy.

17. The system of claim 15, wherein the specified portion is part of the data associated with the logical point-in-time copy.

18. The system of claim 15, wherein creating the logical point-in-time copy comprises creating a side file that keeps track of changes to the production data.

19. The system of claim 15, wherein directly copying the specified portion comprises copying the production data for data that hasn't changed since creation of the logical point-in-time copy, and copying the side file for data that has changed since creation of the logical point-in-time copy.

20. The system of claim 15, wherein the identifier is a session identifier identifying the logical point-in-time copy.
